(19) United States
(12) Patent Application Publication
(10) Pub. No.: US 2026/0247509 A1
(43) Pub. Date: Aug. 20, 2026

(54) LED DRIVING CIRCUIT AND LED LAMP

(71) Applicant: CH LIGHTING TECHNOLOGY CO., LTD., ShaoXing (CN)

(72) Inventors: Yuchao SONG, ShaoXing (CN); Shengjun CAO, ShaoXing (CN); Donghui SU, ShaoXing (CN); Yijiao ZHAO, ShaoXing (CN)

(21) Appl. No.: 19/536,208

(22) Filed: Feb. 10, 2026

(30) Foreign Application Priority Data
Feb. 18, 2025 (CN) 202520263544.0

(51) Int. Cl. H05B 45/3725; H05B 45/10; H05B 45/375

(52) U.S. Cl. CPC H05B 45/3725; H05B 45/10; H05B 45/375

(57) ABSTRACT

An LED driving circuit includes a plurality of AC input terminals, a first operating mode adaptive unit, a rectification and filtering unit, a constant current unit, and an adjustment unit. The plurality of AC input terminals include a first AC input terminal and a second AC input terminal. The first operating mode adaptive unit is coupled between the first AC input terminal and the second AC input terminal. The rectification and filtering unit is coupled to both the first AC input terminal and the second AC input terminal. The adjustment unit is coupled to the constant current unit. On the basis of being compatible with both the mains power and ballast operating modes, the LED driving circuit of the present disclosure can also realize the adjustment of the output power of the LED driving circuit in both operating modes. The present disclosure also provides an LED lamp.

### CROSS-REFERENCE TO RELATED APPLICATIONS

The present application claims priority of Chinese Patent Application No. 202520263544.0, filed on Feb. 18, 2025, the entire contents of which are hereby incorporated by reference.

### TECHNICAL FIELD

The present disclosure relates to the field of lighting technology, in particular to an LED driving circuit and an LED lamp.

### BACKGROUND

Traditional fluorescent lamps have been widely replaced by LED lamps. The original installation positions of fluorescent lamps still have old ballasts, which provide alternating current with a higher voltage than the mains power. Therefore, two types of LED lamps are correspondingly provided on the market, which are called Type A and Type B. Type A refers to LED lamps directly connected after the ballast, and Type B refers to LED lamps connected after the mains power (the ballast is cut off and bypassed), and the luminous power can be adjusted by using the driving power supply.

For non-professionals, there is a certain technical difficulty in distinguishing and installing Type A and Type B. Therefore, the Chinese patent with publication number CN109526093A, “Tube Driving Circuit and LED Lighting Device”, provides a compatible concept. The tube driving circuit is compatible with Type A and Type B. When the tube driving circuit works in the power frequency state of the mains power, the second power supply module works normally, and the first power supply module is turned off by the isolation module. When the tube driving circuit works in the high-frequency and high-voltage alternating current after the ballast, the isolation module is turned on, the first power supply module works normally, and the signal sampling module is triggered at the same time. The signal sampling module disconnects the second power supply module, thereby realizing the compatibility with Type A and Type B as a whole.

Although the above technical content realizes the compatibility with Type A and Type B, the luminous power can only be adjusted in the Type B mode, and cannot be adjusted in the Type A mode.

### SUMMARY

Based on this, it is necessary to address the above technical problems. The present disclosure provides an LED driving circuit that is compatible with both Type A and Type B modes and can adjust the output power.

In a first aspect, the present disclosure provides an LED driving circuit including:
a plurality of AC input terminals, including a first AC input terminal and a second AC input terminal;
a first operating mode adaptive unit coupled between the first AC input terminal and the second AC input terminal;
a rectification and filtering unit coupled to the first AC input terminal and the second AC input terminal and configured for converting alternating current into direct current;
a constant current unit coupled to the rectification and filtering unit and configured for supplying power to an LED load; and
an adjustment unit coupled to the constant current unit and configured for adjusting an output power of the constant current unit.

In an embodiment, a capacitance value of the first capacitor is 10 nF to 20 nF.

In an embodiment, the plurality of AC input terminals further includes a third AC input terminal; the LED driving circuit further includes a second operating mode adaptive unit coupled between the first AC input terminal and the third AC input terminal.

In an embodiment, the second operating mode adaptive unit includes a second capacitor, and the second capacitor is coupled between the first AC input terminal and the third AC input terminal.

In an embodiment, a capacitance value of the second capacitor is 1 nF to 2 nF.

In an embodiment, the constant current unit includes a PWM signal generation unit and a switching transistor. The PWM signal generation unit has a sampling terminal and a driving terminal. The switching transistor includes a first terminal, a second terminal, and a control terminal for controlling an on-off between the first terminal and the second terminal. The driving terminal is coupled to the control terminal of the switching transistor, and the sampling terminal is coupled to the first terminal of the switching transistor.

In an embodiment, the adjustment unit is coupled to the first terminal of the switching transistor, and its resistance value is adjustable.

In an embodiment, the adjustment unit includes a switching element and a plurality of adjustment resistors connected in series with the switching element, and the switching element changes its resistance value by switching an on-off of various adjustment resistors.

In an embodiment, the switching element is configured as a Dual In-line Package switch.

In an embodiment, the constant current unit includes a sampling resistor coupled to the first terminal, and the sampling resistor is connected in parallel with the adjustment unit.

In an embodiment, the LED driving circuit includes a leakage protection unit.

In an embodiment, the leakage protection unit is coupled between the constant current unit and the ground.

In a second aspect, the present disclosure provides an LED lamp including a lamp housing and the LED driving circuit described above is built in the lamp housing.

In an embodiment, the lamp housing includes a lamp tube, and a first end cover and a second end cover located at both ends of the lamp tube. The first end cover is provided with a first pin and a second pin, and the second end cover is provided with a third pin and a fourth pin; the first pin is electrically connected to the first AC input terminal, and the second pin is electrically connected to the second AC input terminal.

In an embodiment, the LED driving circuit includes a third AC input terminal, and the third pin is electrically connected to the third AC input terminal; the LED driving circuit includes a second operating mode adaptive unit, and the second operating mode adaptive unit is coupled between the first AC input terminal and the third AC input terminal.

In the Type B operating mode directly connected to the mains power, the first operating mode adaptive unit has no effect on the LED driving circuit, and the output power of the constant current unit is changed through the adjustment unit at this time. In the Type A operating mode connected to the ballast, the first operating mode adaptive unit enables the ballast to work properly, so that the subsequent constant current unit operates normally, and the adjustment unit can still change the output power of the constant current unit at this time. Therefore, on the basis of being compatible with the mains power Type B operating mode and the ballast Type A operating mode, the present disclosure can also realize the adjustment of the output power of the LED driving circuit in both operating modes.

### BRIEF DESCRIPTION OF DRAWINGS

FIG. 1 is a schematic block diagram of an LED driving circuit in an embodiment of the present disclosure;

FIG. 2 is a schematic block diagram of an LED driving circuit in another embodiment of the present disclosure;

FIG. 3 is a working principle diagram of a constant current unit in an embodiment of the present disclosure;

FIG. 4a illustrates a working principle of a first gear position of an adjustment unit in one embodiment of the present disclosure;

FIG. 4b illustrates a working principle of a second gear position of an adjustment unit in one embodiment of the present disclosure;

FIG. 4c illustrates a working principle of a third gear position of an adjustment unit in one embodiment of the present disclosure;

FIG. 5 is a schematic structural diagram of an LED lamp in an embodiment of the present disclosure;

The reference numerals in the figures are explained as follows:
101. First AC input terminal; 102. Second AC input terminal; 103. Third AC input terminal;
210. First operating mode adaptive unit; 220. Second operating mode adaptive unit;
300. Rectification and filtering unit;
400. Constant current unit; 410. Switching transistor; 411. First terminal; 412. Second terminal; 413. Control terminal; 420. PWM signal generation unit;
500. Adjustment unit; 510. Switching element; 520. First adjustment resistor; 530. Second adjustment resistor;
600. LED load; 700. Leakage protection unit;
800. LED lamp; 810. First end cover; 820. Second end cover; 830. Lamp tube; 811. First pin; 812. Second pin; 813. Third pin; 814. Fourth pin.

### DESCRIPTION OF EMBODIMENTS

The technical solutions in the embodiments of the present disclosure will be clearly and completely described below in conjunction with the accompanying drawings in the embodiments of the present disclosure. Obviously, the described embodiments are only a part of the embodiments of the present disclosure, not all of them. Based on the embodiments in the present disclosure, all other embodiments obtained by those of ordinary skill in the art without making creative efforts shall fall within the protection scope of the present disclosure.

It should be noted that when a component is referred to as being “coupled” to another component, it may be directly connected to the other component or there may be an intermediate component. When a component is considered to be “arranged on” another component, it may be directly arranged on the other component or there may be an intermediate component at the same time.

In the present disclosure, the terms “first”, “second”, etc. are only used for descriptive purposes, and cannot be understood as indicating or implying relative importance or implicitly indicating the quantity or order of the indicated technical features. Therefore, the features defined with “first” and “second” may explicitly or implicitly include one or more of these features. In the description of the present disclosure, the meaning of “plurality” is at least two, such as two, three, etc., unless otherwise clearly and specifically defined.

In the present disclosure, the terms “comprise” and “have” and their any variations are intended to cover non-exclusive inclusion. For example, a system, product or device including a series of units is not necessarily limited to the units clearly listed, but may include other units not clearly listed or inherent to these products or devices.

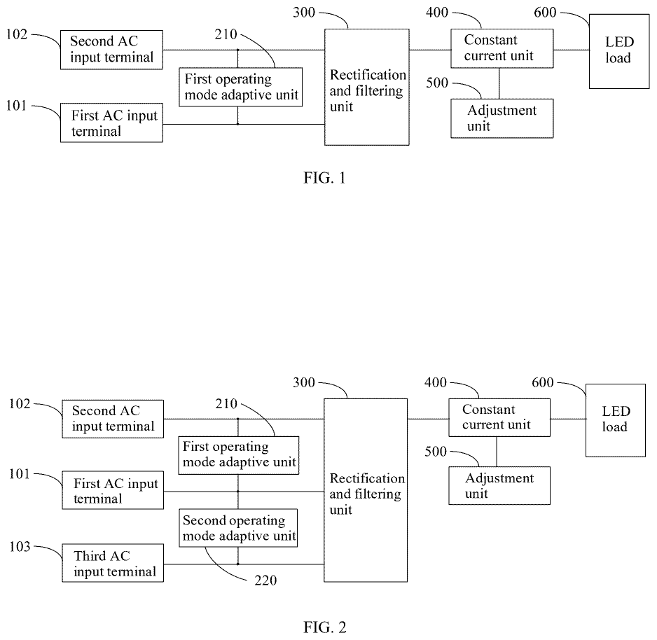

Referring to FIGS. 1 or 2, an embodiment of the present disclosure provides an LED driving circuit, which includes a plurality of AC input terminals, an operating mode adaptive unit, a rectification and filtering unit 300, a constant current unit 400, and an adjustment unit 500.

The AC input terminals include a first AC input terminal 101 and a second AC input terminal 102 for connecting the live wire and neutral wire of alternating current. The alternating current can be power frequency mains power or alternating current output by an electronic ballast on a lamp bracket.

The operating mode adaptive unit includes a first operating mode adaptive unit 210 coupled between the first AC input terminal 101 and the second AC input terminal 102. When the AC input terminal is connected to high-frequency and high-voltage alternating current, the first operating mode adaptive unit 210 is used to the ballast works properly, without affecting the normal operation of subsequent circuit equipment. The “high-frequency and high-voltage alternating current” described herein refers to the alternating current of the LED driving circuit in the Type A mode, specifically the alternating current output by the electronic ballast, usually with a frequency of 20-60 KHz and a voltage range of 100-400V.

In some embodiments, the first operating mode adaptive unit 210 includes a first capacitor coupled between the first AC input terminal 101 and the second AC input terminal 102. Its capacitance value usually needs to be greater than 10 nF, alternatively 10-20 nF, or 15-18 nF.

The rectification and filtering unit 300 includes a coupled rectification unit and a filtering unit, which is coupled to the AC input terminal 101 and the second AC input terminal 102 for converting alternating current into direct current. The rectification module can adopt a full-wave rectifier bridge, and full-wave rectification is realized when two AC input terminals are powered. The filtering module can adopt a filter circuit or other circuits, which is used to filter the direct current to make the current smoother.

The constant current unit 400 can adopt a conventional BUCK circuit, which is coupled to the rectification and filtering unit 300 (specifically the output DC bus). The constant current unit 400 is used to provide a constant current for the LED load. The constant current unit 400 is constructed based on a PWM signal generation unit, and the adjustment unit 500 is coupled to the constant current unit 400 for adjusting the output power of the constant current unit 400.

When the lamp is directly connected to the mains power, it works in the Type B mode. The first operating mode adaptive unit 210 does not interfere with the LED driving circuit, and the output power of the constant current unit 400 can be changed through the adjustment unit 500, thereby changing the luminous power of the lamp.

When the lamp is installed on a lamp bracket with an electronic ballast, it works in the Type A mode. The first operating mode adaptive unit 210 enables the ballast to work properly, so that the subsequent constant current unit 400 can operate normally, and the adjustment unit 500 can still change the output power of the constant current unit 400 at this time.

Referring to FIG. 2, in order to improve the matching of the lamp, in some embodiments, the LED driving circuit further includes a third AC input terminal 103, and a second operating mode adaptive unit 220 is arranged between the first AC input terminal 101 and the third AC input terminal 103.

In some embodiments, the second operating mode adaptive unit 220 includes a second capacitor coupled between the first AC input terminal 101 and the third AC input terminal 103. Its capacitance value usually needs to be greater than 1 nF, alternatively 1-5 nF, 1-2 nF, or 1.5-1.8 nF.

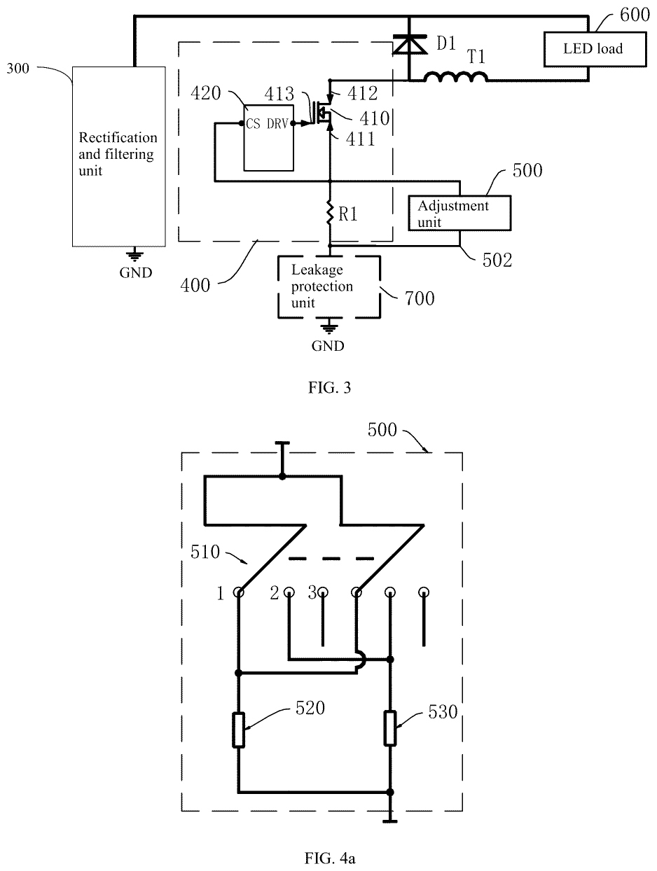

Referring to FIG. 3, the constant current unit 400 includes a switching transistor 410 and a PWM signal generation unit 420. The PWM signal generation unit 420 generally adopts an integrated circuit, which has a sampling terminal CS for receiving external signals and a driving terminal DRV for outputting PWM signals. The switching transistor 410 has a first terminal 411, a second terminal 412, and a control terminal 413. The control terminal 413 is coupled to the driving terminal DRV, and the driving terminal DRV outputs a PWM signal to turn on or off the switching transistor 410.

The sampling terminal CS is coupled to the first terminal 411 of the switching transistor. The sampling terminal CS collects the current output by the first terminal 411, compares it with an internal reference value, and outputs a PWM signal with a corresponding duty cycle. The adjustment unit 500 is coupled to the first terminal 411 and the sampling terminal CS. By changing its own resistance value, it adjusts the output current of the first terminal 411, thereby changing the duty cycle of the PWM signal to adjust the output power of the constant current unit 400. The second terminal 412 of the switching transistor is connected to the LED load 600 to supply power to the LED load 600.

In some embodiments, the switching transistor 410 adopts a MOS transistor (Metal-Oxide-Semiconductor Field-Effect Transistor, MOSFET). The first terminal 411 of the switching transistor 410 corresponds to the drain of the MOS transistor, the second terminal 412 is the source of the MOS transistor, and the control terminal 413 is the gate of the MOS transistor.

As shown in FIG. 3, a freewheeling diode D1 is configured between the source of the MOS transistor and the output bus of the rectification and filtering unit 300. The anode of the freewheeling diode D1 is coupled to the source of the MOS transistor, and the cathode of the freewheeling diode D1 is coupled to the bus. The anode of the LED load is coupled to the bus, and the cathode of the LED load is coupled to the source of the MOS transistor via an inductor T1, thereby realizing the basic function of the BUCK circuit as a whole.

In some embodiments, as shown in FIG. 3, the constant current unit 400 includes a sampling resistor R1 coupled to the first terminal 411. The sampling resistor R1 ensures that the driving circuit can work normally even when the adjustment unit 500 is not coupled. In some embodiments, the LED driving circuit includes a leakage protection unit 700. In some embodiments, the leakage protection unit 700 is coupled between the sampling resistor R1 and the ground. The leakage protection unit 700 is mainly provided to prevent electric shock. It can actively disconnect the circuit when the lamp tube is in contact with the human body. It can adopt the existing technology, which will not be repeated herein.

As shown in FIG. 3, in some embodiments, the adjustment unit 500 is arranged in parallel with the sampling resistor R1. By changing the resistance value of the adjustment unit 500, the current flowing through the first terminal 411 can be changed, thereby adjusting the output power of the constant current unit 400.

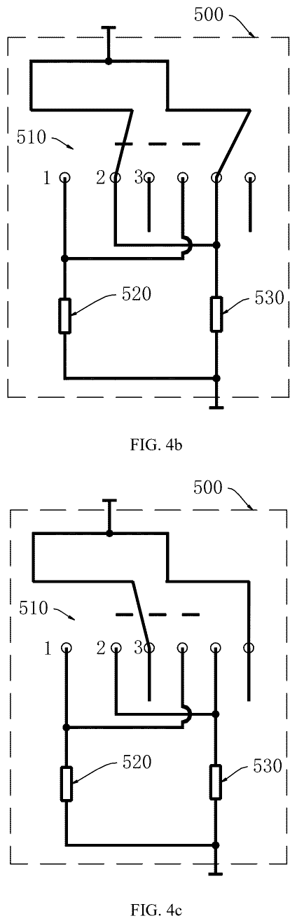

Referring to FIG. 4, in some embodiments, the adjustment unit 500 includes a plurality of adjustment resistors and a switching element 510 for turning on and off different adjustment resistors. In some embodiments, the switching element 510 adopts a Dual In-line Package Switch (DIP switch). As shown in FIG. 4, the adjustment resistors include a first adjustment resistor 520 and a second adjustment resistor 530, and the first adjustment resistor 520 and the second adjustment resistor 530 are connected in series with the switching element 510.

As shown in FIG. 4a, when the switching element 510 is toggled to the first gear, the first resistor 510 is turned on, and the second resistor 520 is turned off. As shown in FIG. 4b, when the switching element 510 is toggled to the second gear, the first resistor 510 is turned off, and the second resistor 520 is turned on. As shown in FIG. 4c, the first resistor 510 is turned off, and the second resistor 520 is turned off.

In the above three gears, because the resistance value between the first terminal 411 and the ground is different, the current flowing through the first terminal 411 is different, so the duty cycle of the PWM signal output by the driving terminal DRV of the PWM signal generation unit is different, so that the output power of the constant current unit 400 is different, thus realizing three-gear power adjustment. Obviously, the number of adjustment resistors can be adjusted adaptively, which can be three or more to realize more gear adjustments.

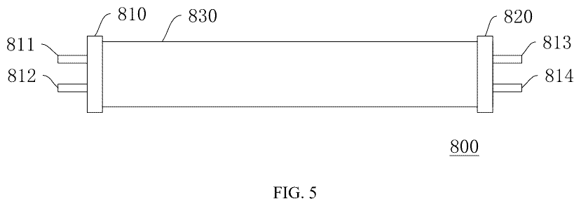

Referring to FIG. 5, an embodiment of the present disclosure provides an LED lamp 800. The LED lamp 800 includes a lamp housing, and the LED driving circuit described above is arranged inside the lamp housing.

In some embodiments, the lamp housing includes a lamp tube 830, and a first end cover 810 and a second end cover 820 located at both ends of the lamp tube 830. The first end cover 810 is provided with a first pin 811 and a second pin 812, and the second end cover 820 is provided with a third pin 813 and a fourth pin 814. The first pin 811 is electrically connected to the first AC input terminal 101, and the second pin 812 is electrically connected to the second AC input terminal 102.

In some embodiments, the third pin 813 is electrically connected to the third AC input terminal 103, and the fourth pin 814 is idle. When the first pin 811 and the second pin 812 are powered, single-ended power supply of the LED lamp 800 is realized. When the first pin 811 and the third pin 813 are powered, double-ended power supply is realized.

The tube part between the two end covers can be a PC tube, a glass tube, or a tubular structure formed by enclosing a radiator and a lampshade. A light-emitting component is arranged inside the tube part. The light-emitting component includes a substrate and LED lamp beads arranged on the substrate. The substrate is strip-shaped, and the LED lamp beads are arranged on the substrate at intervals.

The technical features of the above-described embodiments can be combined arbitrarily. To make the description concise, all possible combinations of the technical features in the above-described embodiments are not described. However, as long as there is no contradiction between the combinations of these technical features, they should be considered as being within the scope of the present specification. When the technical features in different embodiments are reflected in the same drawing, it can be regarded that the drawing also discloses the combination examples of the involved embodiments.

The above-described embodiments only express several implementation modes of the present disclosure, and their descriptions are more specific and detailed, but they should not be construed as limiting the scope of the patent application. It should be pointed out that for those of ordinary skill in the art, without departing from the concept of the present disclosure, several modifications and improvements can also be made, which all fall within the protection scope of the present disclosure.

What is claimed is:

1. An LED driving circuit, comprising:
a plurality of AC input terminals, comprising a first AC input terminal and a second AC input terminal;
a first operating mode adaptive unit, coupled between the first AC input terminal and the second AC input terminal;
a rectification and filtering unit, coupled to the first AC input terminal and the second AC input terminal and configured for converting alternating current into direct current;
a constant current unit, coupled to the rectification and filtering unit and configured for supplying power to an LED load; and
an adjustment unit, coupled to the constant current unit and configured for adjusting an output power of the constant current unit.

2. The LED driving circuit according to claim 1, wherein the first operating mode adaptive unit comprises a first capacitor, and the first capacitor is coupled between the first AC input terminal and the second AC input terminal.

3. The LED driving circuit according to claim 2, wherein a capacitance value of the first capacitor is 10 nF to 20 nF.

4. The LED driving circuit according to claim 1, wherein the plurality of AC input terminals further comprises a third AC input terminal; the LED driving circuit further comprises a second operating mode adaptive unit that is coupled between the first AC input terminal and the third AC input terminal.

5. The LED driving circuit according to claim 4, wherein the second operating mode adaptive unit comprises a second capacitor, and the second capacitor is coupled between the first AC input terminal and the third AC input terminal.

6. The LED driving circuit according to claim 5, wherein a capacitance value of the second capacitor is 1 nF to 2 nF.

7. The LED driving circuit according to claim 1, wherein the constant current unit comprises a PWM signal generation unit and a switching transistor, the PWM signal generation unit comprises a sampling terminal and a driving terminal, the switching transistor comprises a first terminal, a second terminal, and a control terminal for controlling an on-off between the first terminal and the second terminal, the driving terminal is coupled to the control terminal of the switching transistor, and the sampling terminal is coupled to the first terminal of the switching transistor.

8. The LED driving circuit according to claim 7, wherein the adjustment unit is coupled to the first terminal of the switching transistor, and its resistance value is adjustable.

9. The LED driving circuit according to claim 8, wherein the adjustment unit comprises a switching element and a plurality of adjustment resistors connected in series with the switching element, and the switching element changes its resistance value by switching an on-off of various adjustment resistors.

10. The LED driving circuit according to claim 9, wherein the switching element is configured as a Dual In-line Package switch.

11. The LED driving circuit according to claim 7, wherein the constant current unit comprises a sampling resistor coupled to the first terminal, and the sampling resistor is connected in parallel with the adjustment unit.

12. The LED driving circuit according to claim 1, wherein the LED driving circuit comprises a leakage protection unit.

13. The LED driving circuit according to claim 12, wherein the leakage protection unit is coupled between the constant current unit and the ground.

14. An LED lamp, comprising a lamp housing, and the LED driving circuit according to claim 1 arranged inside the lamp housing.

15. The LED lamp according to claim 14, wherein the first operating mode adaptive unit comprises a first capacitor coupled between the first AC input terminal and the second AC input terminal.

16. The LED lamp according to claim 14, wherein the lamp housing comprises a lamp tube, and a first end cover and a second end cover located at two ends of the lamp tube respectively, the first end cover comprises a first pin and a second pin, and the second end cover comprises a third pin and a fourth pin; the first pin is electrically connected to the first AC input terminal, and the second pin is electrically connected to the second AC input terminal.

17. The LED lamp according to claim 16, wherein the plurality of AC input terminals further comprises a third AC input terminal, and the third pin is electrically connected to the third AC input terminal;
the LED driving circuit comprises a second operating mode adaptive unit, and the second operating mode adaptive unit is coupled between the first AC input terminal and the third AC input terminal.

18. The LED lamp according to claim 17, wherein the second operating mode adaptive unit comprises a second capacitor coupled between the first AC input terminal and the third AC input terminal.

19. The LED lamp according to claim 14, wherein the constant current unit comprises a PWM signal generation unit and a switching transistor, the PWM signal generation unit comprises a sampling terminal and a driving terminal, the driving terminal is coupled to the control terminal of the switching transistor, and the sampling terminal is coupled to the first terminal of the switching transistor.

20. The LED lamp according to claim 19, wherein the adjustment unit is coupled to the first terminal of the switching transistor, and its resistance value is adjustable.
